(19) United States
(12) Patent Application Publication
(10) Pub. No.: US 2005/0050242 A1
(43) Pub. Date: Mar. 3, 2005

(54) Method of safely shutting down an embedded system based computer under Linux

(75) Inventor: Chih-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/648,189

(22) Filed: Aug. 27, 2003

(51) Int. Cl. G06F 13/00

(52) U.S. Cl. 710/33

(57) ABSTRACT

The present invention is to provide a method of safely shutting down an embedded system based computer under an OS, the computer including a power switch having a power button being adapted to press for causing an I/O control chip to trigger a system chipset so that a CPU performs the steps of causing the triggered system chip to issue an IRQ to the CPU and receiving the same responsive to triggering the system chipset by the I/O control chip; activating a service routine for determining whether the IRQ is issued by the pressed power button; and terminating all running processes of the OS and performing a soft-off for stopping supplying power from a power supply to the computer if the determination is positive.

### FIELD OF THE INVENTION

The present invention relates to an embedded system based computer run under an OS (operating system) other than Windows and more particularly to a method of safely shutting down the embedded system based computer under Linux.

### BACKGROUND OF THE INVENTION

A variety of OSs are commercially available continuously. A typical example of such OSs is Linux widely used in the Internet. Further, an embedded system is widely employed recently. Thus, whether Linux and an embedded system can provide a more convenient and effective service feature in the future will be an indicator to decide whether the information technology owned by one country is more advanced than other countries.

Linux was developed by a Finish Linus Torvalds when he studied at Helsinki University. Linux is derived from UNIX. But Linux has kernel and file system different from that of UNIX. Linux is popular in computer trade because it is free and its program codes are open. However, Linux as developed by Linus Torvalds is only a kernel of OS for enable a computer to turn on, manage hard disk and memory, and interact with a user. A computer user typically will not satisfy with an OS which is only capable of turning on the computer for operating the same. As such, a variety of integrated Linux variants (e.g., Red Hat Linux, Corel Linux, Open Linux, etc.) are commercially available.

In general, an OS (e.g., Linux) has to support ACPI (Advanced Configuration and Power Interface) for enabling a power switch to safely turn off. Also, any OS has its own central module (i.e., kernel). Kernel is first downloaded into memory for execution when a computer is turned on. Kernel is then resident in the memory. Hence, for reserving more memory space to other applications including OS, it is preferred that a portion of the memory occupied by kernel is as small as possible.

However, ACPI is typically not stored in the memory for saving storage space in an embedded system. As such, an inadvertent pressing of a power button by a user will cause the computer to shut down abnormally. Unfortunately, an abnormal shutdown of Linux tends to crash the computer and Linux. As an end, there is no way restarting the computer.

As stated above, Linux and an embedded system can provide a more convenient and effective service feature in the future. Also, an inadvertent pressing of the power button will cause the computer to shut down abnormally under Linux. Further, the abnormal shutdown of Linux tends to crash the computer and Linux. In another point of view, a multifunctional, powerful, and ergonomic computer is a major trend of computer produced by many computer manufacturers. Thus, it is desirable to provide a computer having more interesting features and being more convenient in use, thereby bringing more business opportunities in order to survive in the competitive information product market.

### SUMMARY OF THE INVENTION

A primary object of the present invention is to provide a method of safely shutting down an embedded system based computer under an OS (e.g., Linux) so as to reduce the size of Linux kernel and maintain the safe shutdown characteristic of ACPI. By utilizing the present invention, the above drawbacks of the prior kernel and BIOS can be overcome.

One object of the present invention is to provide a method of safely shutting down an embedded system based computer under an OS, the computer including a power switch controlled by an I/O control chip, the power switch having a power button, the power button being adapted to press for causing the I/O control chip to trigger a system chipset so that a CPU performs the steps of (a) causing the triggered system chip to issue an IRQ to the CPU and receiving the same responsive to triggering the system chipset by the I/O control chip; (b) activating a service routine for determining whether the IRQ is issued by the pressed power button; and terminating all running processes of the OS and performing a soft-off for stopping supplying power from a power supply to the computer if the determination in the step (b) is positive.

The method of the present invention has the following advantages: Even an inadvertent pressing of the power button will not cause the computer to shut down suddenly, abnormally and will not damage the OS because the present invention can shut down the computer by performing a safe shutdown procedure. Hence, the present invention is devised to greatly increase the function and the practicability of the embedded system. Also, the present invention can be carried out advantageously for surviving in the competitive information product market.

The above and other objects, features and advantages of the present invention will become apparent from the following detailed description taken with the accompanying drawings.

### BRIEF DESCRIPTION OF THE DRAWINGS

FIG. 1 schematically shows a block diagram of the invention;

FIG. 2 is a flow chart illustrating a process done by the CPU for safely shutting down the computer; and

FIG. 3 is a flow chart illustrating a process done by the CPU in running a service routine.

### DETAILED DESCRIPTION OF THE PREFERRED EMBODIMENTS

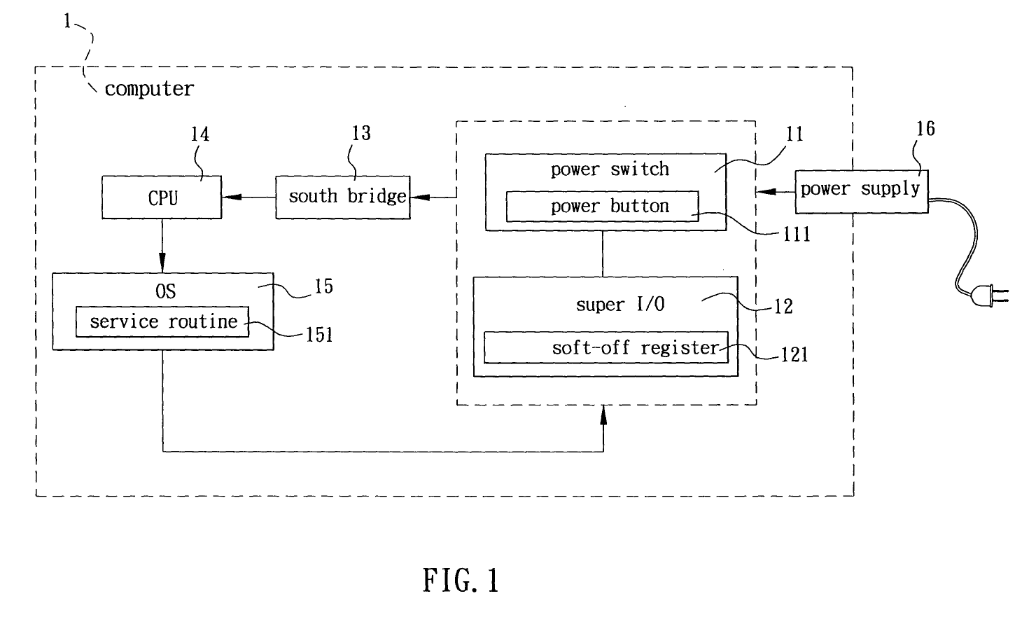

Referring to FIGS. 1, 2 and 3, there is shown a method of safely shutting down an embedded system based computer 1 under a predetermined OS (e.g., Linux). As shown in FIG. 1 specifically, the computer 1 comprises a power switch 11 controlled by an input/output (I/O) control chip (e.g., super I/O) 12, the power switch 11 having a power button 111, the power button 111 being adapted to press for causing the super I/O 12 to trigger a system chipset (e.g., south bridge) 13. The triggered south bridge 13 is operative to issue an interrupt request (IRQ) to a CPU (central processing unit) 14. Next, the CPU 14 activates a service routine 151 of an OS (e.g., Linux) 15 for determining whether IRQ is really issued by the pressed power button 111. If yes, all running processes are terminated. Next, a soft-off is performed for stopping supplying power from a power supply 16 to the computer 1.

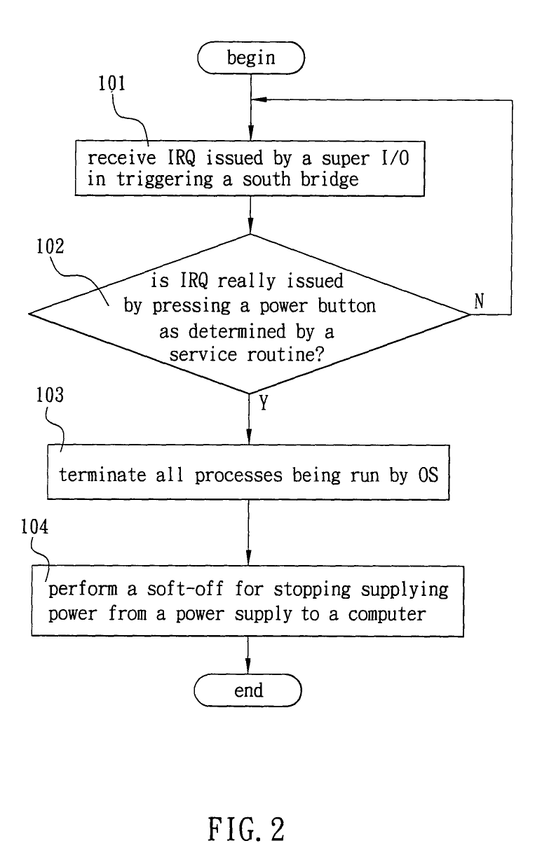

Referring to FIG. 2, a flow chart illustrates a process done by the CPU 14 for safely shutting down the computer 1 in response to the pressing of the power button 111.

In step 101, receive IRQ issued by the super I/O 12 in triggering the south bridge 13.

In step 102, the service routine 151 determines whether IRQ is really issued by the pressed power button 111. If yes, the process goes to step 103. Otherwise, the process loops back to step 101.

In step 103, terminate all processes being run by the OS 15.

In step 104, perform a soft-off for stopping supplying power from the power supply 16 to the computer 1.

By performing the above process, even an inadvertent pressing of the power button 111 by a user will not cause the computer 1 to shut down abnormally and will not result in a crash of the OS 15. For achieving the above purposes, a BIOS (basic input/output system) of the computer 1 has to be configured to have the following features and be capable of setting as follows:
(1) The super I/O 12 will trigger the south bridge 13 in response to the pressing of the power button 111.
(2) The triggered south bridge 13 is operative to issue IRQ to the CPU 14.
(3) Set a soft-off register 121 of the super I/O 12 so that a writing of a set value into the soft-off register 121 and a disabling of the same will disconnect power for turning power off.

Moreover, for achieving the above purposes, Linux 15 has to be configured to have the following features:
(1) It is capable of editing a handler routine for detecting state of the power button 111 (i.e., whether the power button 111 is pressed or not). Hence the handler routine will run a shutdown command (e.g., init0) for terminating all running processes if the power button 111 has been pressed.
(2) It is capable of editing a service routine 151 for responding IRQ. In a case of the CPU 14 received IRQ, Linux 15 will call the service routine 151 for running the handler routine.
(3) It is capable of modifying kernel codes of Linux 15 so as to run the shutdown command in response to pressing the power button 111.
(4) It is capable of editing a soft-off with respect to the soft-off register 121 of the super I/O 12. As such, the soft-off is able to disconnect power from the power supply 16 in response to terminating all processes by the computer 1.

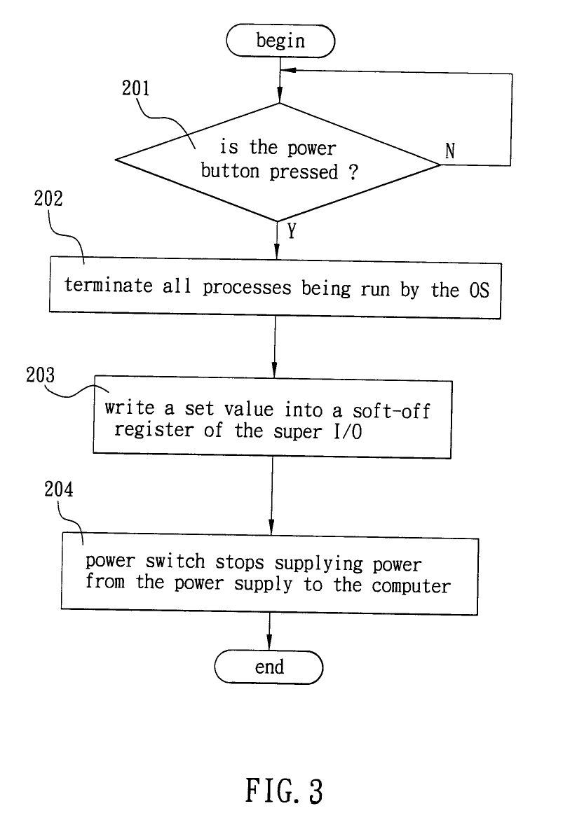

Referring to FIG. 1 again, in the invention the service routine 151 is adapted to determine whether the power button 111 is pressed or not and run the shutdown command of Linux 15 if the power button 111 has been pressed. Further, the CPU 14 will run the service routine 151 by performing the following steps in response to pressing the power button 111 (see FIG. 3).

In step 201, determine whether the power button 111 is pressed. If yes, the process goes to step 202. Otherwise, the process loops back to itself for continuation.

In step 202, terminate all processes being run by the OS 15.

In step 203, write a set value into the soft-off register 121 of the super I/O 12.

In step 204, the power switch 11 is adapted to stop supplying power from the power supply 16 to the computer 1.

In view of the above, by utilizing the invention even an inadvertent pressing of the power button 111 will not cause the computer 1 under Linux to shut down abnormally and will not damage Linux because the invention can shut down the computer 1 by performing a safe shutdown procedure. In brief, the invention is devised to bring a lot of convenience and benefits to vast consumers. Also, a computer manufacturer can win over other competitive computer manufacturers by carrying out the invention.

While the invention has been described by means of specific embodiments, numerous modifications and variations could be made thereto by those skilled in the art without departing from the scope and spirit of the invention set forth in the claims.

1. A method of safely shutting down an embedded system based computer under an OS (operating system), the computer including a power switch controlled by an input/output (I/O) control chip, the power switch having a power button, the power button being adapted to press for causing the I/O control chip to trigger a system chipset so that a CPU (central processing unit) performs the steps of:
(a) causing the triggered system chip to issue an interrupt request (IRQ) to the CPU and receiving the same responsive to triggering the system chipset by the I/O control chip;
(b) activating a service routine of the OS for determining whether the IRQ is issued by the pressed power button; and
(c) terminating all running processes of the OS and performing a soft-off for stopping supplying power from a power supply to the computer if the determination in the step (b) is positive.

2. The method of claim 1, further comprising the step (d) of waiting the system chip to issue an IRQ if the determination in the step (b) is negative.

3. The method of claim 1, wherein responsive to pressing the power button the CPU runs the service routine and performs the steps of:
(e) determining whether the power button is pressed or not;
(f) terminating all processes being run by the OS if the determination in the step (e) is positive;
(g) writing a set value into a soft-off register of the I/O control chip; and
(h) causing the power switch to stop supplying power from the power supply to the computer responsive to writing the set value into the soft-off register and disabling the same.

4. The method of claim 3, further comprising the step (i) of continuously determining whether the power button is pressed or not if the determination in the step (e) is negative.

5. The method of claim 1, wherein the system chipset is a south bridge.
